(19) United States
(12) Patent Application Publication
(10) Pub. No.: US 2021/0062823 A1
(43) Pub. Date: Mar. 4, 2021

(54) COMPRESSOR WITH PORTED SHROUD FOR FLOW RECIRCULATION AND WITH NOISE ATTENUATOR FOR BLADE PASSING FREQUENCY NOISE ATTENUATION, AND TURBOCHARGER INCORPORATING SAME

(71) Applicant: Garrett Transportation I Inc., Torrance, CA (US)

(72) Inventors: Wei Dai, Shanghai (CN); Xiaodong Li, Shanghai (CN); Gaofeng Liu, Shanghai (CN)

(73) Assignee: Garrett Transportation I Inc., Torrance, CA (US)

(21) Appl. No.: 16/558,347

(22) Filed: Sep. 3, 2019

(51) Int. Cl. F04D 29/42; F04D 29/66; F04D 27/02

(52) U.S. Cl. CPC F04D 29/4206; F05D 2220/40; F04D 27/0215; F04D 29/663

(57) ABSTRACT

A compressor includes a compressor housing containing a compressor wheel and defining an inlet duct that leads air into the compressor wheel, and a wheel shroud located adjacent the blade tips and extending upstream from the blades. An annular space is defined between the wheel shroud and an inner surface of the inlet duct. The wheel shroud defines a bleed port that extends into the annular space to bleed a portion of the air entering the compressor wheel into the annular space to be recirculated back into the main flow. A noise attenuator for attenuating compressor blade passing frequency noise is formed as a blind slot located opposite the bleed port and extending for a length L from the radially inner surface of the inlet duct toward the radially outer surface of the inlet duct.

### BACKGROUND OF THE INVENTION

The present disclosure relates to centrifugal compressors used for compressing a fluid such as air, and in which surge of the compressor is controlled by bleeding off a portion of the at least partially compressed fluid and recirculating the portion to the inlet of the compressor. The disclosure relates more particularly to arrangements for attenuating compressor blade passing frequency noise in such centrifugal compressors.

Centrifugal compressors are used in a variety of applications for compressing fluids. A single-stage centrifugal compressor can achieve peak pressure ratios above 5.0 and is much more compact in size than an axial flow compressor of equivalent pressure ratio. Accordingly, centrifugal compressors are commonly used in turbochargers for boosting the performance of gasoline and diesel engines for vehicles.

In turbocharger applications, it is important for the compressor to have a wide operating envelope, as measured between the “choke line” at which the mass flow rate through the compressor reaches a maximum possible value because of sonic flow conditions in the compressor blade passages, and the “surge line” at which the compressor begins to surge. Compressor surge is a compression system instability associated with flow oscillations through the whole compressor system. It is usually initiated by aerodynamic stall or flow separation in one or more of the compressor components as a result of exceeding the limiting flow incidence angle to the compressor blades or exceeding the limiting flow passage loading.

Surge causes a significant loss in performance and thus is highly undesirable. In some cases, compressor surge can also result in damage to the engine or its intake pipe system.

Accordingly, it is known to employ recirculation in centrifugal compressors to delay the onset of surge to lower flow rates. This scheme involves bleeding off a portion of the at least partially compressed air and recirculating the portion to the inlet of the compressor. Recirculation is effective at shifting the compressor surge line to the left on a map of compressor pressure ratio versus corrected flow rate. Applicant has discovered in some cases, however, at certain operating conditions the noise associated with compressor blade passing frequency can tend to be louder than desired. In the case of a turbocharger that employs the centrifugal compressor and that is installed in the engine compartment of an automobile or truck, for instance, at certain operating points the compressor blade passing frequency noise can tend to be an annoyance for occupants of the vehicle. It is desired, therefore, to provide some means for mitigating such noise.

### SUMMARY OF THE DISCLOSURE

The present disclosure is directed to a centrifugal compressor, and to a turbocharger incorporating the compressor, in which the compressor has a fluid recirculation system aimed at controlling surge, and a noise attenuator for attenuating compressor blade passing frequency noise. In accordance with one embodiment disclosed herein, a centrifugal compressor for a turbocharger for compressing air to be delivered to an engine air intake comprises a compressor wheel having a hub defining a rotational axis and having a plurality of circumferentially spaced blades each joined to the hub and extending generally radially outwardly to a blade tip, each of the blades having a leading edge and a trailing edge spaced downstream from the leading edge along a flow direction of a main flow of air through the wheel.

The compressor includes a compressor housing in which the compressor wheel is mounted so as to be rotatable about the rotational axis of the compressor wheel, the compressor housing including an inlet duct through which air enters in a direction generally parallel to the rotational axis of the compressor wheel and is led by the inlet duct into the compressor wheel. A wheel shroud is defined by the compressor housing. The wheel shroud is located radially adjacent the blade tips and extends upstream from the blades with respect to the main flow proceeding along the flow direction, and terminates at a leading edge of the wheel shroud spaced axially upstream of the blade leading edges. The wheel shroud has a radially inner surface wetted by the main flow and has a radially outer surface spaced radially inward of a radially inner surface of the inlet duct wall, such that an annular space is defined between the radially outer surface of the wheel shroud and the radially inner surface of the inlet duct wall.

The wheel shroud proximate the blade tips defines a bleed port that extends generally radially outwardly from the radially inner surface to the radially outer surface of the wheel shroud, into the annular space. The bleed port allows a portion of the air entering the compressor wheel to be bled off through the bleed port into the annular space. The leading edge of the wheel shroud is spaced radially inward of the radially inner surface of the inlet duct, such that the annular space at an upstream end thereof is open to the main flow proceeding along the inlet duct, whereby the portion of air bled off via the bleed port proceeds upstream through the annular space and is recirculated back into the main flow.

The compressor further comprises a noise attenuator for attenuating compressor blade passing frequency noise. The noise attenuator comprises a blind slot located opposite the bleed port and extending for a length L from the radially inner surface of the inlet duct wall toward the radially outer surface of the inlet duct wall.

In one embodiment, the length L of the blind slot is between ⅕ and ¼ of a wavelength of a compressor blade passing frequency at which noise is to be attenuated.

In some embodiments, the bleed port, on a radial-axial plane that contains the rotational axis of the compressor, extends along a first axis that forms an angle α with respect to the rotational axis, wherein 45°≤α≤90°.

In some embodiments, the blind slot, on said radial-axial plane, extends along a second axis that forms an angle β with respect to the rotational axis, and wherein 45°≤β≤135°.

In some embodiments, α and β are equal and have a value between 45° and 90° inclusive.

The blind slot in some embodiments extends circumferentially continuously for 360° about the rotational axis. In other embodiments, the blind slot can be circumferentially discontinuous, comprising a plurality of part-circumference segments that collectively encircle the rotational axis.

### BRIEF DESCRIPTION OF THE DRAWINGS

Having described the present disclosure in general terms, reference will now be made to the accompanying drawing(s), which are not necessarily drawn to scale, and wherein:

FIG. 1 is an axial cross-sectional view of a turbocharger in accordance with one embodiment of the invention;

FIG. 2 is an axial cross-sectional view of a compressor housing for the turbocharger of FIG. 1;

FIG. 3 is similar to FIG. 2, but shows a second embodiment of the invention;

FIG. 4 shows a third embodiment of the invention; and

FIG. 5 shows a fourth embodiment of the invention.

### DETAILED DESCRIPTION OF THE DRAWINGS

The present disclosure will now be described in fuller detail with reference to the above-described drawings, which depict some but not all embodiments of the invention(s) to which the present disclosure pertains. These inventions may be embodied in various forms, including forms not expressly described herein, and should not be construed as limited to the particular exemplary embodiments described herein. In the following description, like numbers refer to like elements throughout.

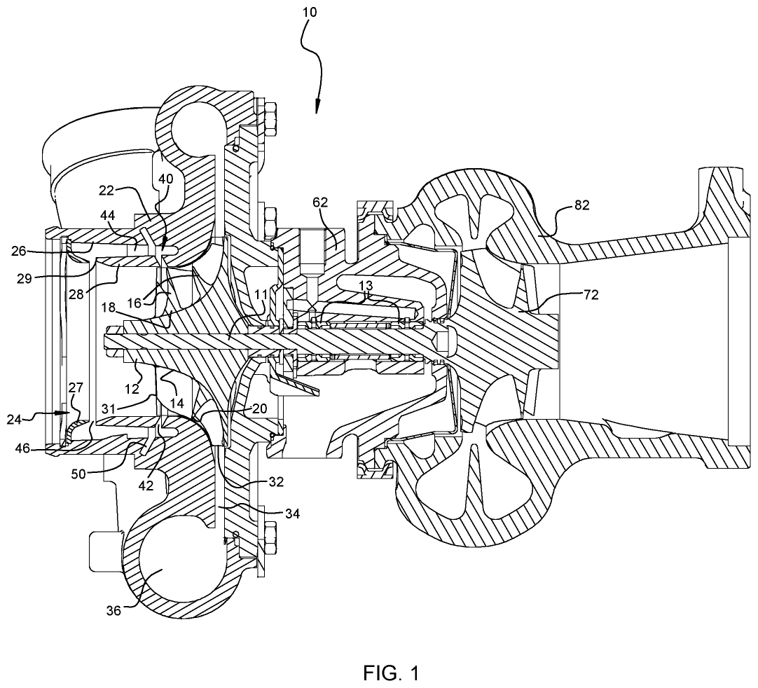

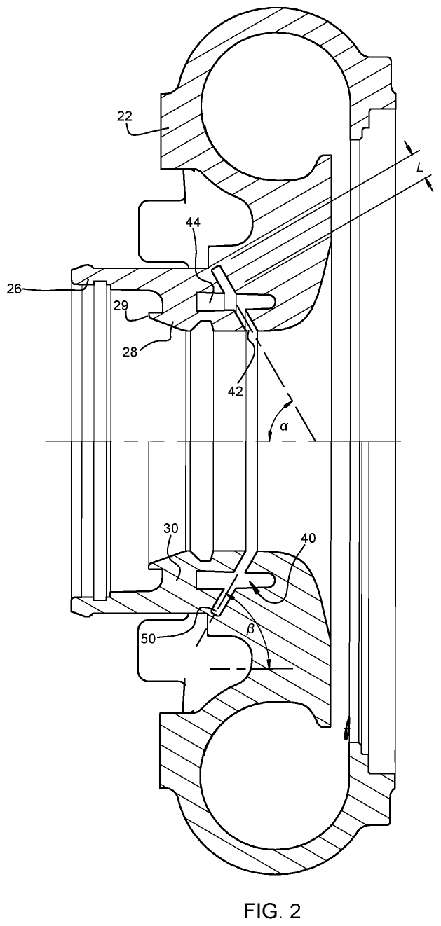

A turbocharger 10 having a compressor in accordance with a first embodiment of the invention is depicted in FIG. 1, and FIG. 2 depicts the compressor housing of the turbocharger. The turbocharger comprises a compressor wheel 12 mounted within a compressor housing 22 and having a hub 14 and a plurality of circumferentially spaced blades 16 joined to the hub and extending generally radially outwardly therefrom. Each blade has a root 18 attached to the hub and an opposite tip 20. The compressor wheel 12 is connected to a shaft 11 that is rotatable about a rotational axis and is driven by a turbine wheel 72 affixed to the opposite end of the shaft 11 and mounted within a turbine housing 82. The shaft is supported in bearings 13 that are housed in a center housing 62 disposed between the compressor housing and the turbine housing.

The compressor housing 22 includes an inlet duct 24 formed by a duct wall 26 that encircles the axis. The compressor housing further includes a wheel shroud 28 that is radially adjacent the tips 20 of the compressor blades and, together with the hub 14 of the compressor wheel, defines a flowpath for fluid to flow through the blade passages of the compressor wheel. The wheel shroud 28 extends upstream from the compressor wheel and terminates at a leading edge 29 spaced axially upstream of the leading edges of the compressor blades 16. The inlet duct 24 is configured such that the fluid flow approaches the leading edges 31 of the compressor blades 16 in a direction substantially parallel to the rotational axis. The flowpath defined by the hub and wheel shroud is configured to turn the fluid flow radially outwardly as the fluid flows through the blade passages. The fluid exits the blade passages at the blade trailing edges 32 in a generally radially outward direction (although also having a swirl or circumferential component of velocity) and passes through a diffuser passage 34 into a discharge volute 36 that comprises a generally toroidal or annular chamber surrounding the compressor wheel.

The compressor further includes a bleed flow recirculation system 40 for controlling surge of the compressor. The recirculation system includes a bleed port 42 defined in the wheel shroud 28 at a location intermediate the leading edges 31 and trailing edges 32 of the compressor blades. The bleed port in one embodiment is a substantially uninterrupted full 360° annular port that encircles the tips of the compressor blades. At a given compressor speed when compressor discharge pressure is increased or when compressor mass flow is reduced, a portion of the fluid flowing through the blade passages is bled off through the bleed port 42. This bleed portion is partially compressed and thus at a higher total pressure than the fluid entering the compressor inlet duct 24. The bleed portion also has a circumferential or swirl component of velocity because of the action of the rotating compressor blades.

The bleed port 42 is connected to an annular space or passage 44 defined in the compressor housing 22. The annular passage 44 is defined between a radially outer surface of the wheel shroud 28 and a radially inner surface of the inlet duct wall 26. In one embodiment, the passage 44 comprises a substantially uninterrupted full 360° annular passage, except for the presence of a relatively small number of support struts 30 that extend between the inlet duct wall 26 and the wheel shroud 28 as further described below. The passage 44 extends in a generally axial direction opposite to the direction of the main fluid flow in the inlet duct 24, to a point spaced upstream (with respect to the main fluid flow) of the compressor blade leading edges.

The compressor further includes a flow-guiding member 27. The flow-guiding member is an annular member that extends from the inlet duct wall 26 radially inwardly and axially downstream to a trailing edge of the flow-guiding member, which is proximate but axially spaced upstream from the leading edge 29 of the wheel shroud 28, such that there is a 360° gap 46 between the trailing edge of the flow-guiding member and the leading edge of the wheel shroud. The flow-guiding member serves to substantially prevent the main flow of air from passing radially inwardly through the gap 46 while allowing the recirculated air to pass through the gap. The flow-guiding member also helps to direct the recirculated air through the gap 46. Thus, a portion of the air passing through the compressor wheel 12 flows out through the bleed port 42 into the annular space 44, then upstream within the annular space, and finally is injected, as recirculated air, through the gap 46 back into the main flow approaching the compressor wheel. This recirculation of air serves to help control surge of the compressor.

With reference to FIG. 2, the compressor also includes a noise attenuator for attenuating noise associated with the compressor blade passing frequency (CBPF). The noise attenuator comprises a blind slot 50 located opposite the bleed port 42 and extending for a length L from the radially inner surface of the inlet duct wall 26 toward the radially outer surface of the inlet duct wall. The length L of the blind slot 50 is selected based on the frequency of the CBPF noise to be attenuated. After identifying the blade passing frequency F to be attenuated, and therefore the wavelength λ corresponding to that frequency, the length L is selected to be between ⅕ and ¼ of the wavelength λ. The blind slot 50 acts essentially as a quarter-wave resonator. An incident sound wave of the blade passing frequency F enters the blind slot and is reflected from the end wall of the slot and back along the path by which it entered; the incident wave and the reflected wave destructively interfere with each other, thereby attenuating the sound at that frequency.

As a non-limiting example to illustrate the sizing of the blind slot, suppose CBPF noise is found to be troublesome at a compressor rotational speed of 90,000 rpm, and the compressor wheel has seven blades. The blade passing frequency is related to the number of blades, N, and rotational speed as

F=N*RPM÷60

Therefore, the blade passing frequency in this example is equal to 7*90,000÷60=10,500 Hz. The wavelength corresponding to this frequency is related to the speed of sound and the frequency as

$$\begin{matrix}λ = {V}_{sound} \div F \\ = 340 m \text{/} s \div 10500 Hz \\ = 0.0324 m ( 32.4 mm )\end{matrix}$$

Accordingly, based on ⅕ to ¼ of this wavelength, the blind slot should have a length L between about 6.5 mm and about 8.1 mm.

In accordance with the invention, various configurations of bleed ports 42 and noise attenuator blind slots 50 can be employed. Advantageously, in each case the mouth of the blind slot 50 should be in alignment with the exit of the bleed port 42. Orientations of the bleed port and blind slot can vary, however, subject to this general constraint. As illustrated in FIG. 2, on a radial-axial plane that contains the rotational axis of the compressor wheel, the bleed port 42 extends along a first axis that makes an angle α with respect to the rotational axis. The blind slot 50, on said radial-axial plane, extends along a second axis that makes an angle β with respect to the rotational axis. In accordance with the invention, the angles α and β each can vary. In the embodiment of FIG. 2, the value of a is about 60° and the value of β is equal to a. Thus, in this first embodiment, the bleed port and the blind slot are colinearly aligned along an axis oriented at 60° to the rotational axis.

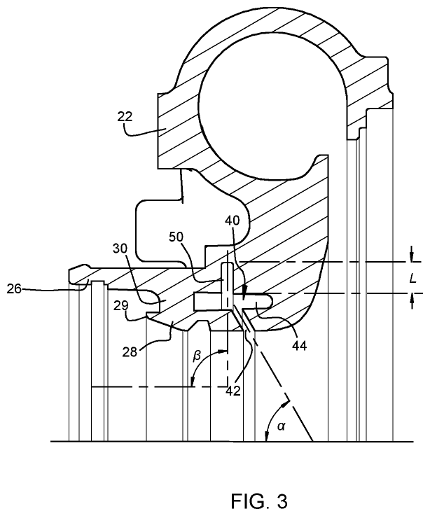

A second embodiment of the invention is shown in FIG. 3. In this embodiment, a is about 60° and β is about 90°. As in the first embodiment, the mouth of the blind slot 50 is aligned with the exit from the bleed port 42.

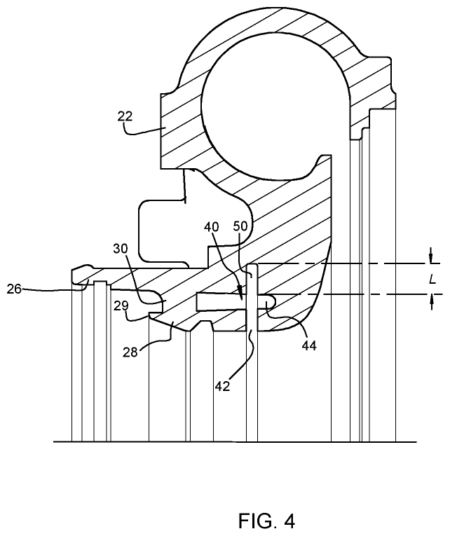

A third embodiment of the invention is shown in FIG. 4. In this embodiment, both the bleed port 42 and the blind slot 50 are oriented and aligned along a radial direction, or in other words, α and β are both equal to 90°.

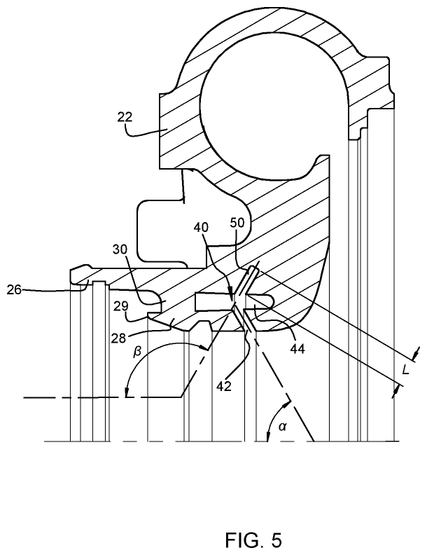

A fourth embodiment of the invention is depicted in FIG. 5. In this embodiment, α is about 60° and β is about 120°. As in the other embodiments, the mouth of the blind slot 50 is aligned with the exit from the bleed port 42.

More generally, in accordance with the invention, the value of a can vary from about 45° to about 90° inclusive, and the value of β can vary from about 45° to about 135° inclusive.

In some embodiments of the invention, the blind slot 42 can extend circumferentially continuously for 360° about the rotational axis of the compressor. In other embodiments, the blind slot can be circumferentially discontinuous, comprising a plurality of part-circumference segments that collectively encircle the rotational axis.

Persons skilled in the art, on the basis of the present disclosure, will recognize that modifications and other embodiments of the inventions described herein can be made without departing from the inventive concepts described herein. Specific terms used herein are employed for explanatory purposes rather than purposes of limitation. Accordingly, the inventions are not to be limited to the specific embodiments disclosed, and modifications and other embodiments are intended to be included within the scope of the appended claims.

What is claimed is:

1. A centrifugal compressor for a turbocharger, comprising:
a compressor wheel having a hub defining a rotational axis and having a plurality of circumferentially spaced blades each joined to the hub and extending generally radially outwardly to a blade tip, each of the blades having a leading edge and a trailing edge spaced downstream from the leading edge along a flow direction of a main flow of air through the wheel, the compressor wheel being affixed to one end of a shaft rotatable about the rotational axis;
a compressor housing in which the compressor wheel is mounted so as to be rotatable about the rotational axis of the compressor wheel, the compressor housing including an inlet duct through which air enters in a direction generally parallel to the rotational axis of the compressor wheel and is led by the inlet duct into the compressor wheel, the inlet duct being formed by an inlet duct wall encircling the rotational axis and having a radially outer surface and a radially inner surface;
a wheel shroud located radially adjacent the blade tips, the wheel shroud extending upstream from the blades with respect to the main flow proceeding along the flow direction and terminating at a leading edge of the wheel shroud spaced axially upstream of the blade leading edges, the wheel shroud having a radially inner surface wetted by the main flow and having a radially outer surface spaced radially inward of the radially inner surface of the inlet duct wall such that an annular space is defined between the radially outer surface of the wheel shroud and the radially inner surface of the inlet duct wall;
the wheel shroud defining a bleed port proximate the blade tips and extending generally radially outwardly from the radially inner surface of the wheel shroud to the radially outer surface of the wheel shroud, into the annular space; and
a noise attenuator for attenuating compressor blade passing frequency noise, the noise attenuator comprising a blind slot located opposite the bleed port and extending for a length L from the radially inner surface of the inlet duct wall toward the radially outer surface of the inlet duct wall, the blind slot encircling the rotational axis.

2. The centrifugal compressor of claim 1, wherein the length L of the blind slot is between ⅕ and ¼ of a wavelength of a compressor blade passing frequency at which noise is to be attenuated.

3. The centrifugal compressor of claim 2, wherein the bleed port, on a radial-axial plane that contains the rotational axis of the compressor, extends along a first axis that forms an angle α with respect to the rotational axis, and wherein 45°≤α≤90°.

4. The centrifugal compressor of claim 3, wherein the blind slot, on said radial-axial plane, extends along a second axis that forms an angle β with respect to the rotational axis, and wherein 45°≤β≤135°.

5. The centrifugal compressor of claim 4, wherein α and β are equal and have a value between 45° and 90° inclusive.

6. A turbocharger, comprising:
the compressor of claim 1;
a center housing coupled with the compressor housing and containing bearings for the shaft; and
a turbine comprising a turbine wheel affixed to an opposite end of the shaft, and a turbine housing that contains the turbine wheel.

7. The turbocharger of claim 6, wherein the length L of the blind slot is between ⅕ and ¼ of a wavelength of a compressor blade passing frequency at which noise is to be attenuated.

8. The turbocharger of claim 7, wherein the bleed port, on a radial-axial plane that contains the rotational axis of the compressor, extends along a first axis that forms an angle α with respect to the rotational axis, and wherein 45°≤α≤90°.

9. The turbocharger of claim 8, wherein the blind slot, on said radial-axial plane, extends along a second axis that forms an angle β with respect to the rotational axis, and wherein 45°≤β≤135°.

10. The turbocharger of claim 9, wherein α and β are equal and have a value between 45° and 90° inclusive.

11. The turbocharger of claim 6, wherein the compressor housing further comprises a flow-guiding member comprising an annular member that extends from the inlet duct wall radially inwardly and axially downstream to a trailing edge of the flow-guiding member, the trailing edge of the flow-guiding member being proximate to but axially spaced upstream from the leading edge of the wheel shroud, such that a 360° gap is defined between the trailing edge of the flow-guiding member and the leading edge of the wheel shroud.
